(19) United States
(12) Patent Application Publication
(10) Pub. No.: US 2016/0268681 A1
(43) Pub. Date: Sep. 15, 2016

(54) Three-Element Antenna Array for Wireless Handsets

(71) Applicant: BOARD OF TRUSTEES OF MICHIGAN STATE UNIVERSITY, East Lansing, MI (US)

(72) Inventors: S. Ratnajeevan H. Hoole, Okemos, MI (US); Paul Hoole, Dehiwela (LK)

(21) Appl. No.: 15/065,441

(22) Filed: Mar. 9, 2016

Related U.S. Application Data
(60) Provisional application No. 62/130,993, filed on Mar. 10, 2015.

(51) Int. Cl. H01Q 3/26; H01Q 3/36

(52) U.S. Cl. CPC H01Q 3/2611; H01Q 3/36

(57) ABSTRACT

A multiple antenna beam steering device includes three-element array, which are controlled to increase power reception in the direction of the desired signal while simultaneously minimizing signal reception in one or more directions of interference, using selective weighting of received signals, and specified summation stages to produce combined array factors that are used to form a beam pattern that is both maximized in at least one signal direction and minimized in at least one interference direction.

### CROSS-REFERENCE TO RELATED APPLICATION

This application claims the benefit of U.S. Application Ser. No. 62/130,993, filed Mar. 10, 2015, entitled “Three-Element Antenna Array for Wireless Handsets,” which is hereby incorporated by reference in its entirety.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Antenna beam-forming is largely confined to stationary base stations. Current beam-forming techniques combine the electromagnetic signals of array antenna elements to form a desired output. The array antenna behaves like a space domain filter, whereby interference signals that are being transmitted and/or received from certain directions are suppressed, and desired signals arriving or being transmitted are amplified.

In mobile communications, a major problem surrounding the operation of line of sight (LOS) systems is multipath interference. The most desired path of a signal beam would be a direct ray or direct beam-path. Direct beam paths often does not exist between a transmitter and receiver. Instead, a receiver may receive a signal via multiple beam paths, each reflected and/or diffracted along different paths before reaching the transmitter. One of these indirect beam paths can cause fading and sometimes complete blockage of a desired signal. Moreover, when a receiver receives a signal along multiple beam paths multipath fading can result, which can produce data corruption, signal nulling, and increasing or decreasing of signal amplitude.

In order to address multipath interference, multiple antenna transceivers are used. These transceivers can provide better beam steering in the hopes of reducing multipath interference. However, widespread use of multiple antenna receivers is limited, especially for mobile handsets. Some of the biggest hurdles to using multiple antenna elements on mobile handsets centers on the significant battery power requirements from these antennas. Weight requirements for the additional hardware and signal processing are also limiting. Not only should a multiple antenna transceiver include circuitry to steer a beam pattern in a desired direction, that transceiver would typically also include separate circuitry to null unwanted signals in other directions. The need for these separate circuits or processing adds considerably to the power and weight loads for a mobile handset device.

### SUMMARY OF THE INVENTION

The present techniques allow for selective signal dampening and bolstering to be carried out simultaneously in a mobile station (MS). The present techniques are able to provide simultaneous maximizing of a transmit/receive beam in a desired direction and nulling of unwanted signals in other directions. The techniques provide faster processing than would be theoretically achieved via a dedicated signal processor. The techniques impose minimal memory requirements on the mobile device and are able to achieve high signal clarity, with little noise.

A multiple antenna beam steering device is provided. In some examples, the device is implemented using only a three-element array, while other examples may include additional antenna elements. With the present techniques, however, simultaneous power increase and interference minimization can occur with as little as three antenna elements. These antenna elements may be controlled to increase power reception in the direction of the desired signal while simultaneously minimizing signal reception in one or more directions of interference. To achieve this simultaneity, the three electrical signal paths of the three antenna elements may be selectively combined (or split). For example, one of the antenna (e.g., antenna A1) may be used primarily for nullifying the interference signals coming in from different directions. Another antenna (e.g., A3) may be used for amplification of the desired signal in the desired direction. These two antennas may have their received (or transmitted) electrical signals weighted by corresponding weighting factors, including identical weighting factors. A third antenna (e.g., A2), is un-weighted and used for adding signal strength to A1 and A3.

The techniques herein may be used to exploit the diversity in multiple-input and multiple-output (MIMO) systems, where at times the reflected signal can be utilized as the main signal when the direct signal is limited (for example, cut down in strength due to shadowing created by buildings). The techniques are described as implemented within a mobile device, such as a cell phone, mobile smart-phone, personal digital assistant, tablet computer, portable medial player, home telephone, wearable computing device, smart watch, phablet, or other wireless communication-enable device, collectively referred to herein also as “mobile stations” or “mobile devices.” But it will be appreciated that the techniques may be implemented in wireless networking devices compatible with any number of one or more wireless communication networks, including cellular networks, WIFI networks (under the 802.11 standards), WiMAX networks (under the 802.16 standards), Bluetooth, and/or others. Such other devices include base stations.

In this way, an antenna radiation field pattern may be optimized in multiple directions and using a signal processor to make the mobile station antenna assembly simultaneously increase reception of the desired signal (or increase radiation in the desired direction, when operating as transmitter) and cut off signals from interferers (e.g. other mobile users and reflected signals). That would be for receiver operation. For transmit operation, the mobile station antenna assembly can minimize radiation in directions other than the direction of the receiver.

In accordance with an example, a wireless receiver device comprises: a three-element antenna array comprising a first antenna element, a second antenna element, and a third antenna element, where each is a wire dipole antenna; and a beamformer controller coupled to the three-element antenna array and comprising a separate receive signal path for each of the first antenna element, the second antenna element, and the third antenna element, wherein the receive signal path for the first antenna element includes a first weighting element to produce a first weighted receive signal and the receive signal path of the second antenna element includes a second weighting element to produce a second weighted receive signal, and wherein the receive signal path for the third antenna element is unweighted relative to the other receive signal paths to produce an unweighted receive signal, the beamformer controller further comprising (i) a first antenna weighting factor stage configured to determine a minimization antenna weighting factor from the first weighted receive signal and the unweighted receive signal and (ii) a second antenna factor stage configured to determine a maximization antenna weighting factor from the second weighted receive signal and the unweighted received signal, the beamformer controller further comprising a combined array factor stage configured to produce a combined array factor from the minimization antenna factor and the maximization antenna factor, and an array factor stage to produce a combined array factor from the first summing element and the second summing element, wherein the array factor stage is coupled to a transmitter or receiver stage for multiplying the combined array factor with a single element radiation pattern to form a beam pattern that is both maximized in at least one signal direction and minimized in at least one interference direction.

In accordance with an example, a method of determining a beam steering factor for receiving and/or transmitting a signal on an optimized beam pattern, the method comprises: receiving, at a beamformer controller, (i) a first electrical signal collected by a first antenna element, (ii) a second electrical collected by a second antenna element, and (iii) a third electrical signal collected by a third antenna element, where the first antenna element, the second antenna element, and the third antenna element are each a wire dipole antenna and where each collectively form a three-element antenna array; weighting, at the beamformer controller, the first electrical signal by a first weighting value; weighting, at the beamformer controller, the second electrical signal by a second weight value; maintaining, at the beamformer controller, the third electrical signal as unweighted relative to the first weighting value and the second weighting value; determining, at the beamformer controller, a first antenna weighting factor from the weighted first electrical signal and the third electrical signal; determining, at the beamformer controller, a second antenna weighting factor from the weighted second electrical signal and the third electrical signal; and combining, at the beamformer controller, the first antenna weighting factor and the second antenna weighting factor to form a combined array factor that corresponds to the beam steering factor for the optimized beam pattern, such that the array factor stage when multiplied by a single element radiation pattern forms a beam pattern that is both maximized in a signal direction and minimized in an interference direction.

### BRIEF DESCRIPTION OF THE DRAWINGS

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates a schematic of three-element array antenna assembly configuration, in accordance with an example.

FIG. 2 illustrates a schematic of the three-element array antenna assembly of FIG. 1, showing data signal paths and processing for simultaneous beam steering and interference nulling, in accordance with an example.

FIGS. 3a and 3b illustrate plots of beam patterns showing beam forming and nulling resulting from different three-element array antenna configurations, in accordance with an example.

FIG. 4 illustrates plots of beam patterns showing beam forming in different designed directions.

FIG. 5 illustrates plots of beam patterns showing beam nulling in different designed direction.

FIGS. 6a, 6b and 6c illustrate plots of beam patterns in another example of beam steering for θ_{d}=30° and θᵢ=60° to yield simultaneous maximum and null directions.

### DETAILED DESCRIPTION

Although the following text sets forth a detailed description of numerous different embodiments, it should be understood that the legal scope of the description is defined by the words of the claims set forth at the end of this patent and equivalents. The detailed description is to be construed as providing examples only and does not describe every possible embodiment since describing every possible embodiment would be impractical. Numerous alternative embodiments could be implemented, using either current technology or technology developed after the filing date of this patent, which would still fall within the scope of the claims.

A mobile station beam-forming processor makes use of the estimation of the position of the mobile station (with respect to a base station). That estimation may include known techniques to determine the position or angle of arrival (AoA). With this information known, the mobile station processor coupled to the multiple array antenna system herein may perform weight calculations, to beam steer the radiation pattern toward the base station or toward the most desired beam position or angle. The mobile station process may perform weight calculations in a similar manner for nulling in the interference direction.

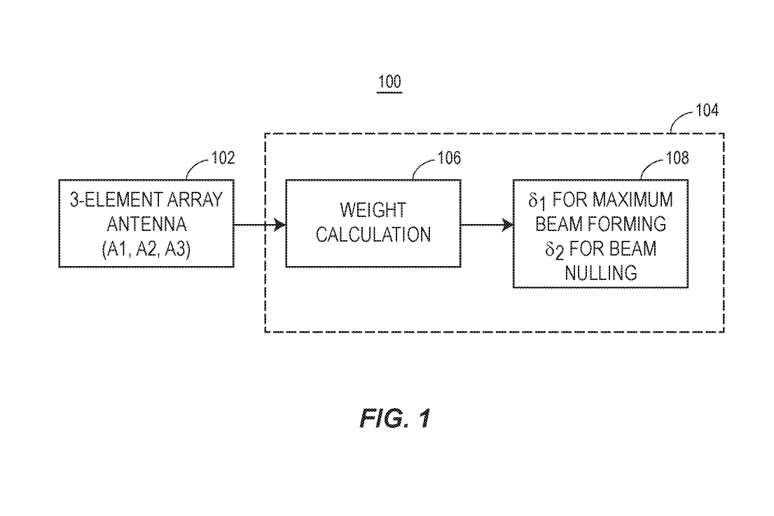

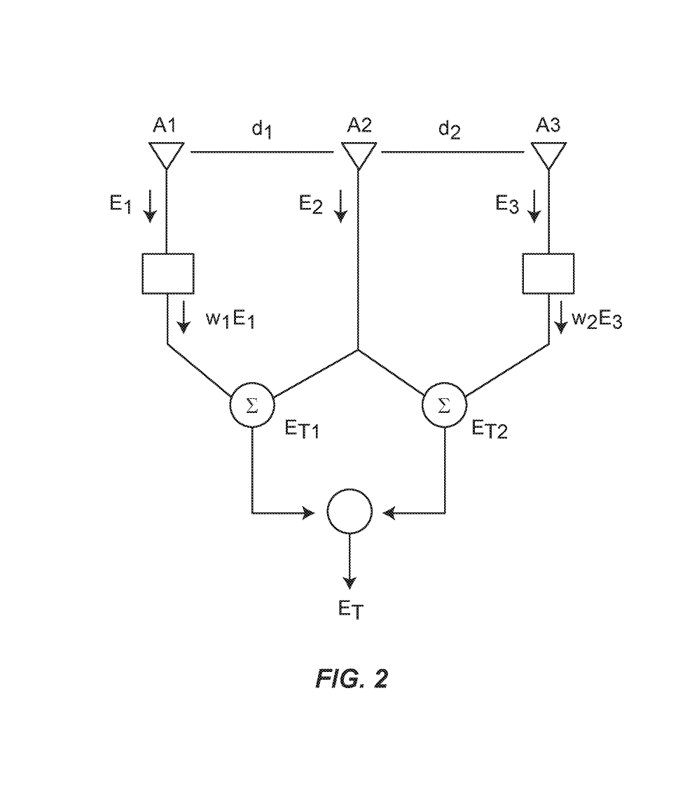

FIG. 1 illustrates a schematic of an example three-element array antenna control system 100 that may be used in a mobile station beam forming processor. The system 100 includes a three-element array 102, with antennas labeled A1, A2, and A3. A beam-forming controller 104 is used to receive signal strength information from the antenna array 102 and estimate the two phase shifts to be imposed on the received signal before combining the two complex vectors with an unoperated third part (E₂) of the signal, as shown in FIG. 2. One phase shift takes account of the AoA of the desired signal, and the other phase shift accounts for the AoA of the interference. While not shown, it will be understood that the beam-forming controller 104 may include one or more processors and one or more (non-transitory) computer readable memories storing instructions that are executed on the one or more processors. In the illustrated example, the processor 104 includes a weighting factor stage 106 that may be configured to determine a minimization antenna weighting factor and a maximization antenna weighting factor, from weighted and unweighted received signals. The controller 104 further includes an array factor stage 108 that can determine combined array factors, e.g., one from the minimization antenna weighting factor and from the maximization antenna weighting factor and another from summing elements to produce beam factors that are used for beam pattern forming. The stage 108 may determine a beam steering factor array that is applied to the three-element element antenna array 102 in transmitting a signal to a target or in receiving a signal from a target.

A detailed schematic of an example configuration of the system 100 is shown in FIG. 2. An advantage of this configuration is that the system can perform beam steering to the desired direction and nulling to the interference direction simultaneously. Elements A1, A2, and A3 are antenna, spaced by distances d₁ and d₂, as shown. Each antenna A1, A2, and A3 produces a received signaled E₁, E₂, and E₃, respectively. Weighting factors (w₁ and w₂) are applied to selective of these received signals, as shown, to produce weight received signals w₁E₁ and w₂E₂, for example. Summing elements, Σ, are provided as shown to produce E_{T1} and E_{T2}) discussed further below. In the hardware implementation of the structure shown in FIG. 2, an amplifier to double the signal strength of element A₂ may be used since E₂ is used twice to combine it separately with both E₁ and E₂, but otherwise the signal from A₂ is not signal weighted. At the output of element A₁ is a digital beam steering weight w₁ (a complex vector), which is dynamically set from the electromagnetic radiation equations to maximize the beam towards the desired direction (e.g. towards the base station).

In the examples herein, we considered the array factor of the antenna. The final radiation pattern would be the array factor multiplied by the single element radiation pattern. In this way, the techniques herein may be applied to any array antenna; the final radiation pattern is obtained by multiplying the array factor by the single element radiation pattern. In the case of an isotropic antenna element, the final radiation pattern is identical to the array factor.

In operation, the three-element antenna (A1, A2, and A3) may be placed along an arbitrary axis, e.g., the x-axis. Since θ is measured from the z-axis, and φ from the x-axis, we set φ=0. In this example, the configuration may obtain the array factor on the zx-plane. The final, three-dimensional array factor is the array factor for the zx-plane swung around by 360 degrees along the x-axis.

At the output of antenna element A₃ is another weight w₂, which is used to create a null towards the interference direction (e.g. another base station or mobile station). The electric field at the output of antenna elements A₁ and A₂ after summation is E_{T1}=w₁E₁+E₂. The array factor of E_{T1} is given by

$$\begin{matrix}{AF}_{1} = 2 cos \frac{{ψ}_{1}}{2} , \\ where & ( 1 ) \\ {ψ}_{1} = {kd}_{1} sin θ cos ϕ + {δ}_{1} , & ( 2 )\end{matrix}$$

from which we obtain the first electrical phase shift,

δ₁=kd₁ sinθ_{d} cosφ_{d} (Maximize). (3)

In equation (3), the subscript d of θ_{d} and φ_{d} refers to the direction of the desired signal. The electric field at the output of antenna elements A₂ and A₃ is E_{T2}=E₂+w₂E₃. Similarly, the array factor of E_{T2} and the associated phase shift are given by

$$\begin{matrix}{AF}_{2} = 2 cos \frac{{ψ}_{2}}{2} , \\ where & ( 4 ) \\ {ψ}_{2} = {kd}_{2} sin θ cos ϕ + {δ}_{2} , \\ and & ( 5 ) \\ {δ}_{2} = π - {kd}_{2} sin {θ}_{i} cos {ϕ}_{i} ( Minimize / Nulling ) , & ( 6 )\end{matrix}$$

where the subscript i in θᵢ and φᵢ refers to the direction of the interfering signal.

Thus, the configuration includes have a 2-element array formed of antenna elements A₁ and A₂. And, noting that the signal in A₂ is doubled, the configuration includes an exactly similar 2-element array formed of antenna elements A₂ and A₃. That is, the configuration includes 2-element array made up of the two arrays. Therefore the total electric field and array factor of the system may be obtained from

E_{T}=E_{T1}+E_{T2}, (7)

and

AF=AF₁×AF₂. (8)

For the configuration of FIG. 2, the system has four parameters which may be varied to control the beam pattern. These parameters are δ₁, δ₂ and the spacing between the adjacent elements, d₁ and d₂ in terms of wavelength λ. The distances are selectively chosen before fabrication, since once selected they typically would not be varied. The signal processor may however, control on line the two-phase shifts to keep tuning the beams as the mobile station moves. To achieve the optimum beam pattern, these parameters must be carefully designed with consideration not only of the electromagnetic fields but also hand-set size. The computational burden and time are kept to a minimum by keeping the magnitudes of both weights constant and at 1. Only the phases of the weights are controlled.

For the three-element array antenna, we may assume that the mobile station moves only along the ground and thus may be defined only by the horizontal plane angle θ, resulting in the following simplified expressions for normalized array factors and phase shift angles:

$$\begin{matrix}{AF}_{N 1} = cos \frac{ψ}{2} , \\ where & ( 9 ) \\ ψ = {kd}_{1} sin θ + {δ}_{1} , & ( 10 ) \\ {δ}_{1} = - {kd}_{1} sin {θ}_{d} ( Maximize ) , \\ and & ( 11 ) \\ {AF}_{N 2} = cos \frac{ψ}{2} , & ( 12 )\end{matrix}$$

where in turn

Ψ=kd₂ sinθ′δ₂, (13)

and

δ₂=π−kd₂ sinθ₁ (Minimize/Nulling). (14)

A complete three-dimensional processor will take into account the vertical plane angle q as well. We note that the estimation of the phase shift angles is completely defined and does not need any numerical adaptive signal processor to estimate these angles for each position of the mobile station.

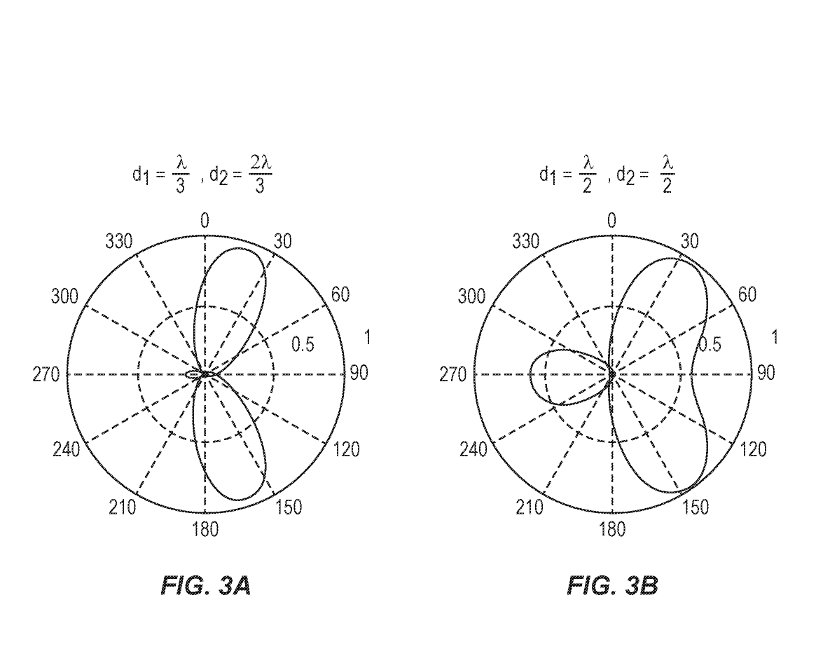

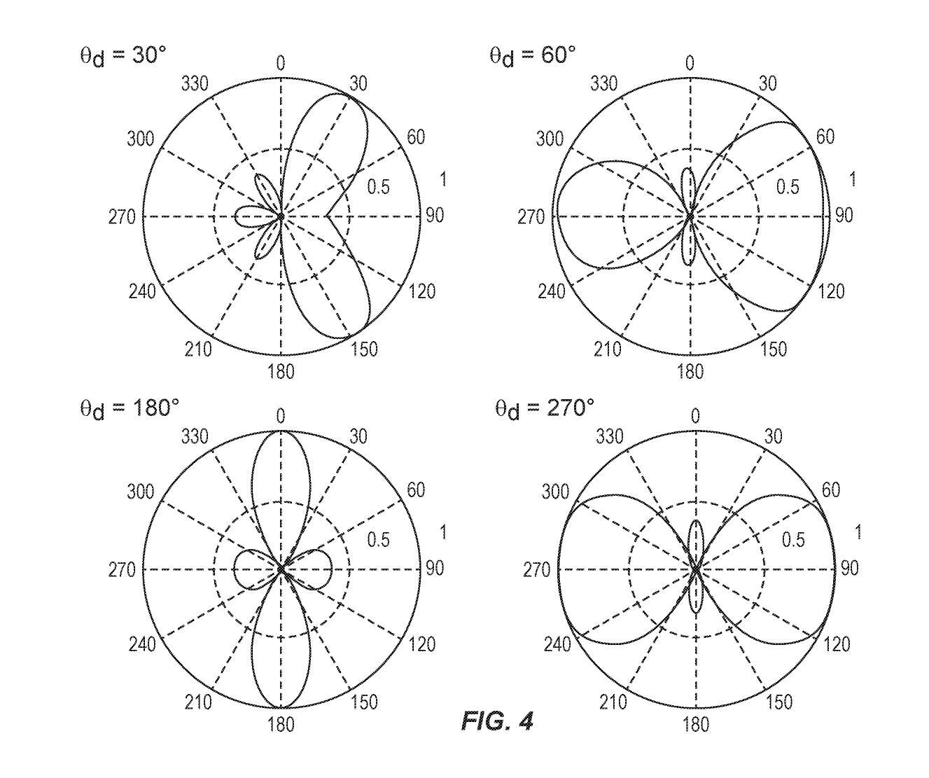

FIGS. 3(a) and 3(b) illustrate the simulation results for the three-element antenna beam patterns, which are identically equal to the resultant array factor AF=AF_{N1}×AF_{N2} according to equation (8) where the individual radiation patterns of the elements may be set to be isotropic. The resultant patterns are obtained for d₁=λ/3 and d₂=2 λ/3 as in FIG. 3(a) and d₁=λ/2 and d₂=λ/2 as in FIG. 3(b).

In FIG. 3(a), the AF of the beam formed to direction 40° is not quite maximum (AF maximum=1, the normalized array factor) from the process of multiplication of the array factors, though strong (about AF=0.8). However, FIG. 3(a) shows that AF=0 (null) exactly towards the interference direction θᵢ=330°. This is because as the array factors are multiplied, multiplication by a zero always yields a zero so that nullification is exactly accomplished. From FIG. 3(b) with different distances of separation, AF of the 40° direction is maximum (AF=1) and AF=0 for the 330° direction. However, the beam pattern is sharper in FIG. 3(a) compared to FIG. 3(b), which means that radiation in unwanted directions is confined to a narrow region. These differences are due to the different distances of separation between the three elements.

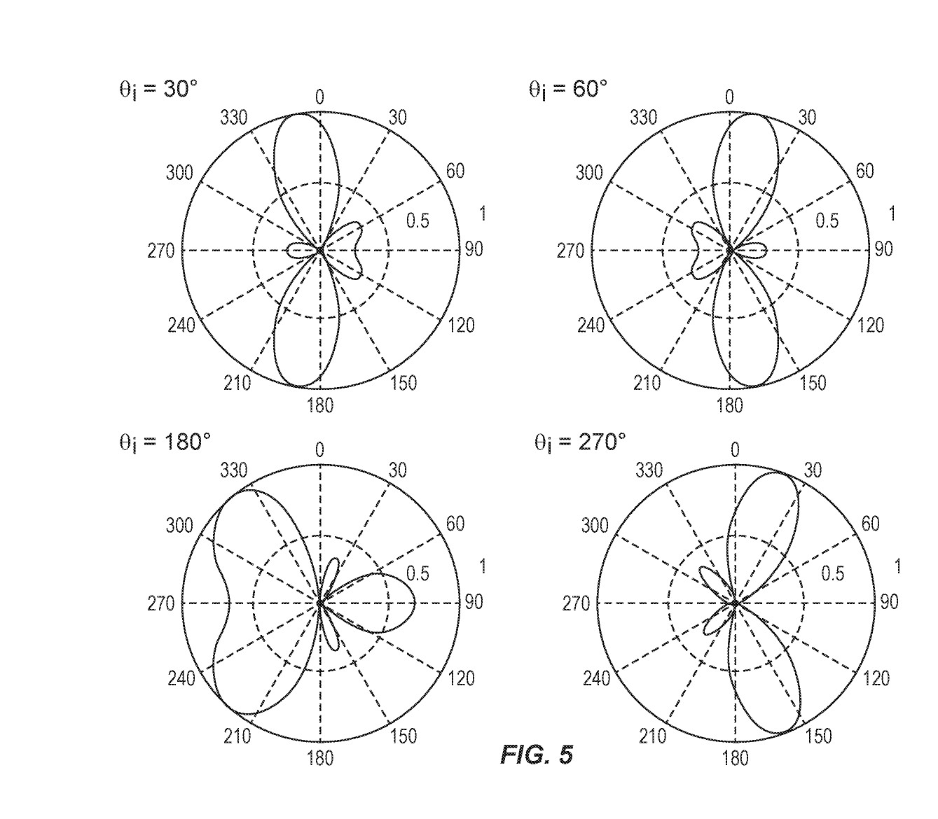

FIG. 4 gives further examples of producing beam forming in any desired direction. FIG. 5 illustrates beam nullification in any desired direction. What we observe with the present techniques is that both beam forming and nullification may be achieved exactly by changing the two values of δ: δ₁ and δ₂. As the two array factors AF₁ and AF₂ are multiplied, the nulling direction will be preserved exactly and the beam maximization will be very close to the maximum. It is very little to give up for the advantages accrued in terms of light weight by obviating the computing equipment for extra signal processing.

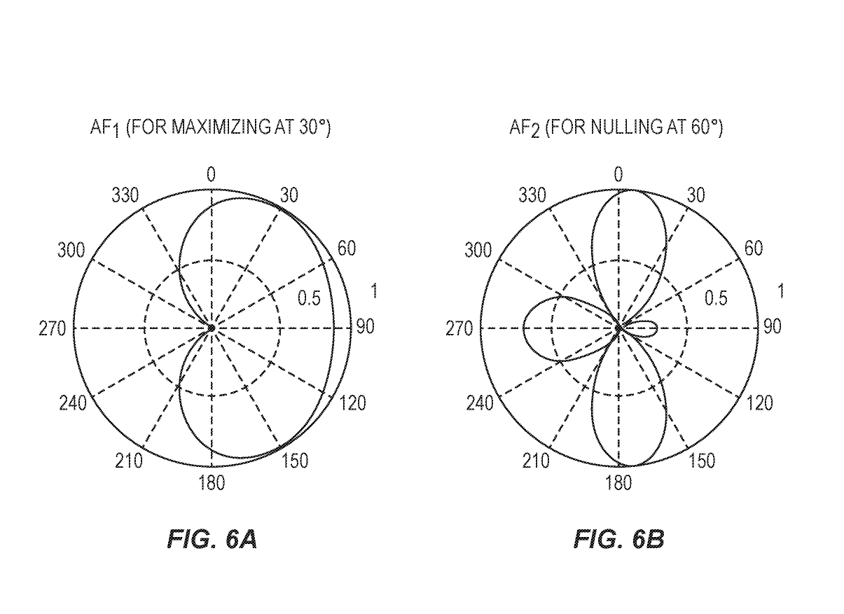

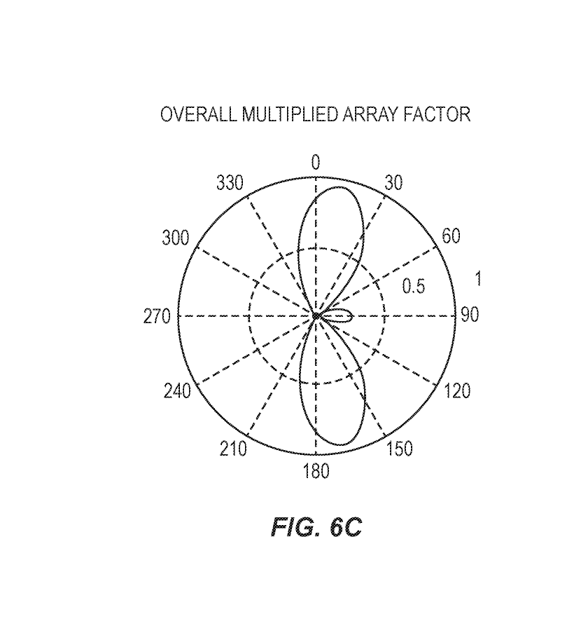

As a final example, FIG. 6 presents results for the desired direction of 30° and the nulling direction of 60°. While greater accuracies may be obtained through more elements and case-by-case computations with onboard equipment, these results establish that for all practical purposes a three-element system without the burden of computational equipment accomplishes our design goals.

The three-element array antenna shown in FIG. 2 allows for simultaneous suppression of interference or unwanted signal, while steering the beam to receive or transmit signals in the desired direction. The electromagnetic signal processor presented here needs no brute force computation to beam form, since it depends on an analytical solution for the resultant array factor of the three-element electric field of a three element antenna. The practical implication of this is that very light hand-sets may be made. The electronic phase shift δ is given through the microprocessor doing the signal processing to the received signals at antennas 1 and 3, through the weights w₁ and w₂. That is, in this case we keep weights w₁ and w₂ simple, thus cutting down on memory and computational speed, by keeping the magnitudes of the weights to one, but giving only phase shifts to signals received by antennas A₁ and A₂. That is magnitudes of w₁ and w₂ are 1, but the electronic phase angles of w₁ and w₂ are δ₁ and δ₂ respectively. Moreover, greater simplicity of design may be achieved by not doing any signal processing at antenna A₂, except for amplifying the signal by 2 in order to use for combining with w₁E₁ and w₂E₂. The distances of separation between the two elements have a modifying effect primarily on the pointing angle of the beam maxima in relation to the AoA of the desired signal.

This detailed description is to be construed as providing examples only and does not describe every possible embodiment, as describing every possible embodiment would be impractical, if not impossible. One could implement numerous alternate embodiments, using either current technology or technology developed after the filing date of this application.

What is claimed:

1. A wireless receiver device comprising:
a three-element antenna array comprising a first antenna element, a second antenna element, and a third antenna element, where each is a wire dipole antenna; and
a beamformer controller coupled to the three-element antenna array and comprising a separate receive signal path for each of the first antenna element, the second antenna element, and the third antenna element, wherein the receive signal path for the first antenna element includes a first weighting element to produce a first weighted receive signal and the receive signal path of the second antenna element includes a second weighting element to produce a second weighted receive signal, and wherein the receive signal path for the third antenna element is unweighted relative to the other receive signal paths to produce an unweighted receive signal,
the beamformer controller further comprising (i) a first antenna weighting factor stage configured to determine a minimization antenna weighting factor from the first weighted receive signal and the unweighted receive signal and (ii) a second antenna factor stage configured to determine a maximization antenna weighting factor from the second weighted receive signal and the unweighted received signal,
the beamformer controller further comprising
a combined array factor stage configured to produce a combined array factor from the minimization antenna factor and the maximization antenna factor, and
an array factor stage to produce a combined array factor from the first summing element and the second summing element,
wherein the array factor stage is coupled to a transmitter or receiver stage for multiplying the combined array factor with a single element radiation pattern to form a beam pattern that is both maximized in at least one signal direction and minimized in at least one interference direction.

2. The wireless receiver device of claim 1, wherein the first antenna factor stage comprises a first summing element configured to sum the first weighted receive signal and the unweighted receive signal.

3. The wireless receiver device of claim 2, wherein the second antenna factor stage comprises a second summing element configured to sum the second weighted receive signal and the unweighted receive signal.

4. The wireless receiver device of claim 1, wherein the array factor stage comprises a summation stage configured to sum the minimization antenna factor and the maximization antenna factor to produce the combined array factor.

5. The wireless receiver device of claim 4, wherein the beamformer controller is configured to determine, from the combined array factor, a beam steering factor array that is applied to at least the first antenna element and the second antenna element in transmitting a signal to a target.

6. The wireless receiver device of claim 5, wherein the beam steering factor array comprises a first transmitting phase shifting factor for the first antenna element and a second transmitting phase shifting factor for the second antenna element.

7. The wireless receiver device of claim 1, wherein the third antenna element is spaced equidistant to the first antenna element and to the second antenna element.

8. A method of determining a beam steering factor for receiving and/or transmitting a signal on an optimized beam pattern, the method comprising:
receiving, at a beamformer controller, (i) a first electrical signal collected by a first antenna element, (ii) a second electrical collected by a second antenna element, and (iii) a third electrical signal collected by a third antenna element, where the first antenna element, the second antenna element, and the third antenna element are each a wire dipole antenna and where each collectively form a three-element antenna array;
weighting, at the beamformer controller, the first electrical signal by a first weighting value;
weighting, at the beamformer controller, the second electrical signal by a second weight value;
maintaining, at the beamformer controller, the third electrical signal as unweighted relative to the first weighting value and the second weighting value;
determining, at the beamformer controller, a first antenna weighting factor from the weighted first electrical signal and the third electrical signal;
determining, at the beamformer controller, a second antenna weighting factor from the weighted second electrical signal and the third electrical signal; and
combining, at the beamformer controller, the first antenna weighting factor and the second antenna weighting factor to form a combined array factor that corresponds to the beam steering factor for the optimized beam pattern, such that the array factor stage when multiplied by a single element radiation pattern forms a beam pattern that is both maximized in a signal direction and minimized in an interference direction.

9. The method of claim 8, wherein the first weighting value and the second weight value have the same magnitude but differ in phase.

10. The method of claim 8, wherein determining the first antenna weighting factor comprises summing the weighted first electrical signal and the third electrical signal.

11. The method of claim 8, wherein determining the second antenna weighting factor comprises summing the weighted second electrical signal and the third electrical signal.

12. The method of claim 11, wherein combining the first antenna weighting factor and the second antenna weighting factor comprises summing the first antenna weighting factor and the second antenna weighting factor.

13. The method of claim 8, further comprising determining the first antenna weighting factor as a minimization antenna weighting factor that identifies a minimized lobe portion of the beam pattern.

14. The method of claim 8, further comprising determining the second antenna weighting factor as a maximization antenna weighting factor that identifies a maximized lobe portion of the beam pattern.

15. The method of claim 8, further comprising weighting the first electrical signal by the first weighting value to minimize the beam pattern in a first direction; and simultaneously weighting the second electrical signal by the second weight value to maximize the beam pattern in a second direction different from the first direction.

16. The method of claim 8, further comprising determining, from the combined array factor, a beam steering factor array and applying the beam steering factor array to the first antenna element and the second antenna element to transmit a signal to a target on the optimized beam pattern.
